(19) United States
(12) Patent Application Publication
(10) Pub. No.: US 2019/0375491 A1
(43) Pub. Date: Dec. 12, 2019

(54) VERTICAL STABILIZER FOR AN AIRCRAFT

(71) Applicant: Airbus Operations Limited, Bristol (GB)

(72) Inventor: Thomas WILSON, Bristol (GB)

(21) Appl. No.: 16/437,415

(22) Filed: Jun. 11, 2019

(30) Foreign Application Priority Data
Jun. 12, 2018 (GB) 1809534.9

(51) Int. Cl. B64C 5/02; B64C 5/16; B64C 13/16

(52) U.S. Cl. CPC B64C 5/02; B64C 13/16; B64C 5/16

(57) ABSTRACT

A vertical stabilizer for an aircraft having a fixed portion for attachment to an aircraft fuselage and a moveable portion coupled to the fixed portion by a hinge. The moveable portion of the vertical stabilizer is able to rotate about the hinge. As gusts of wind act on the moveable portion of the vertical stabilizer, the moveable portion rotates about the hinge preventing any loading due to the gusts from being transferred onto the aircraft fuselage, thereby providing gust load alleviation.

### FIELD OF THE INVENTION

The present invention relates to a vertical stabilizer for an aircraft and a method of controlling a vertical stabilizer of an aircraft.

### BACKGROUND OF THE INVENTION

The design constraints that determine the size of vertical stabilizers in modern aircraft are based upon the requirement for the aircraft to maintain lateral stability in the event of an engine failure during aircraft take-off or climb flight phases. This is required in order to account for the yawing moment that such an event causes to act on the aircraft. In order to achieve the necessary yaw control under such circumstances, vertical stabilizers are designed to exhibit relatively large aerodynamic surfaces.

However, during flight phases such as cruise, aircraft vertical stabilizers optimised for the engine failure during aircraft take-off or climb flight phases are oversized for the amount of lateral stability required during cruise. It has been found that the size of aircraft vertical stabilizers during cruise conditions are detrimental to aircraft performance. Due to their large size, gusts of wind, as well as turbulent flight conditions acting on the vertical stabilizer can result in high loads being placed on the aircraft, which in turn requires a heavier aircraft structure in order to withstand such high loads.

Possible methods of gust load alleviation on the vertical stabilizer would be complex and as such potential benefits are reduced by, for example, the need to accommodate additional actuators and actuator failure cases which may negate any potential weight-saving benefits gained from such systems.

Therefore, the present invention aims to provide an improved vertical stabilizer.

### SUMMARY OF THE INVENTION

A first aspect of the invention provides a vertical stabilizer for an aircraft comprising a fixed portion for attachment to an aircraft fuselage, and a moveable portion coupled to the fixed portion by a hinge, wherein a hinge line of the hinge is inclined at an angle of at least 5 degrees, but less than 40 degrees, relative to a longitudinal axis of the aircraft fuselage.

A second aspect of the invention provides a vertical stabilizer for an aircraft, having a fixed portion for attachment to an aircraft fuselage, a moveable portion coupled to the fixed portion by a hinge extending between a leading edge and a trailing edge of the vertical stabilizer, and a locking system configured to releasably lock the moveable portion relative to the fixed portion, wherein the hinge is a semi-passive hinge such that the moveable portion is configured to freely rotate about the hinge relative to the fixed portion when the locking system is unlocked.

A third aspect of the invention provides a method for controlling a vertical stabilizer of an aircraft, the vertical stabilizer having a fixed portion attached to an aircraft fuselage, and a moveable portion coupled to the fixed portion by a hinge, wherein a hinge line of the hinge is inclined at an angle of at least 5 degrees, but less than 40 degrees, relative to a longitudinal axis of the aircraft fuselage, and a locking system for locking the moveable portion relative to the fixed portion, the method comprising monitoring at least one aircraft condition, and selectively locking or unlocking the locking system based at least in part on the monitored aircraft condition.

The aircraft longitudinal axis is typically referred to as the horizontal axis, x, or ‘roll axis’ of the aircraft and is one of the three principle axes of the aircraft. The roll axis is perpendicular to the pitch axis, y, and perpendicular to the vertical or yaw axis, z. These three principle axes intersect at the aircraft centre of gravity.

The term ‘flare angle’ is used here to refer to the acute angle formed between the hinge line and the longitudinal axis of the aircraft fuselage. A flare angle of at least 5 degrees may be beneficial as an acute angle lower than this may not be able to maintain a positive flare angle relative to the free stream when the angle of attack of the aircraft becomes negative. A flare angle greater than 40 degrees may lead to issues with flutter.

As used here, ‘freely rotate’ is used to mean that the moveable portion is not actively constrained from rotation about the hinge during rotation about the hinge, but some friction resistance at the hinge to that rotation can be expected.

The vertical stabilizer is commonly found on the aft end of the aircraft fuselage, or empennage, and is otherwise known as a vertical tail or vertical tailplane (VTP), or fin. Some aircraft have a single vertical stabilizer which is attached directly to the aircraft fuselage or empennage (rear fuselage). The vertical stabilizer typically extends upwardly from the aircraft fuselage. Other aircraft have a plurality of vertical stabilizers attached indirectly to the aircraft fuselage, usually by attachment of the vertical stabilizers to a horizontal stabilizer which is attached directly to the aircraft fuselage. The vertical stabilizers may extend upwardly, downwardly, or both upwardly and downwardly from the vertical stabilizer. As used here, the attachment of the fixed portion of the vertical stabilizer to the aircraft fuselage is intended to be either direct or indirect.

The hinge line may be inclined at an angle of at least 10 degrees relative to the longitudinal axis of the aircraft fuselage.

The hinge line may be inclined at an angle of at least 15 degrees, or at least 17.5 degrees, relative to the longitudinal axis of the aircraft fuselage.

The vertical stabilizer may have a span. The hinge may be positioned outboard of a mid-span location. The mid-span location is defined as the location 50% of the span from the root end of the vertical stabilizer. The root end is the end attached to the aircraft fuselage, or to a horizontal stabilizer of the aircraft, depending on the aircraft configuration.

The vertical stabilizer may further comprise a locking system configured to releas ably lock the moveable portion relative to the fixed portion.

The hinge may be a semi-passive hinge such that the moveable portion is configured to freely rotate about the hinge relative to the fixed portion when the locking system is unlocked. Therefore, the hinge may be semi-aeroelastic.

The term “semi-passive” is used to mean a vertical stabilizer wherein the moveable portion is actively locked via a locking system, but that is passively moved by external loads acting on the moveable portion when the locking system is released. Therefore, a “semi-passive” hinge does not require an actuator to move the moveable portion relative to the fixed portion when the locking system has been released.

The vertical stabilizer may comprise an actuator configured to move the moveable portion relative to the fixed portion. The actuator may be a rotary actuator, a linear actuator, or any other suitable type of actuator.

Therefore, the hinge may be a fully active hinge. The term “fully active” is used to mean a vertical stabilizer wherein the moveable portion is actuated to move relative to the fixed portion using an actuator.

The fixed portion of the vertical stabilizer may define a first plane, and the moveable portion of the vertical stabilizer may define a second plane. The locking system may be configured to lock the moveable portion relative to the fixed portion when the first plane and the second plane are co-planar.

The fixed portion may define a first plane, and the moveable portion may define a second plane, and the vertical stabilizer may further comprise a stop to restrict an angle between the first plane and the second plane. The stop may be configured to restrict the included angle between the first plane and the second plane to be at most 45 degrees.

The vertical stabilizer may comprise a rudder, wherein at least a portion of the rudder is provided on the moveable portion.

The fixed portion of the vertical stabilizer may be attached to the fuselage of an aircraft.

The aircraft may comprise a locking system controller coupled to the locking system and configured to lock or release the locking system at one or more flight conditions of the aircraft.

The locking system controller may be coupled to one or more sensors. The locking system controller may be configured to automatically lock or release the locking system dependent at least in part on an input received from the sensor(s).

The one or more sensors may be adapted to sense one or more of: angle of attack, air speed, air speed vector, turbulence, sideslip (beta) angle, lateral acceleration (Ny, Nz), or an engine condition.

In the method of the third aspect, the aircraft condition may be an aircraft flight phase, an aircraft speed, a wind speed, a turbulence level, or an engine condition.

### BRIEF DESCRIPTION OF THE DRAWINGS

Embodiments of the invention will now be described with reference to the accompanying drawings, in which:

FIG. 1 illustrates a plan view of an aircraft;

FIG. 2 illustrates a detailed schematic side view of a folding vertical stabilizer of the aircraft illustrated in FIG. 1;

FIG. 3 illustrates a detailed schematic side view of a locking system of the vertical stabilizer illustrated in FIG. 2;

FIG. 4 illustrates a front view of the folding vertical stabilizer illustrated in FIGS. 1 to 3 in a neutral, unfolded position;

FIG. 5 illustrates a front view of the folding vertical stabilizer illustrated in FIGS. 1 to 4 in a folded position;

FIG. 5A illustrates a schematic front view of the folding vertical stabilizer illustrated in FIGS. 1 to 4 showing the aerodynamic loading acting on the folding vertical stabilizer when it is in a folded position;

FIG. 6 illustrates a detailed schematic side view of an aircraft according to an alternative example;

FIG. 7 illustrates a detailed schematic side view of an aircraft having an alternative rudder configuration according to an alternative example;

FIG. 8 illustrates a front view of the folding vertical stabilizer of an aircraft shown in FIG. 6 or FIG. 7 in a folded position; and

FIG. 8A illustrates a schematic front view of the folding vertical stabilizer illustrated in FIG. 8 showing the aerodynamic loading acting on the folding vertical stabilizer when it is in a folded position.

### DETAILED DESCRIPTION OF EMBODIMENT(S)

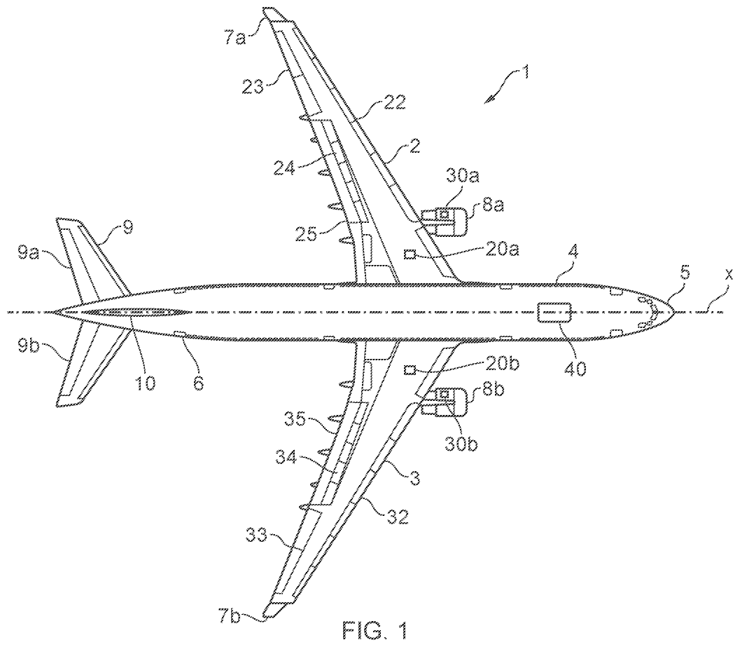

FIG. 1 illustrates a typical fixed wing aircraft 1 having a port wing 2 and starboard wing 3 carrying wing mounted engines 8a and 8b respectively. The wings 2, 3 extend from a fuselage 4 having a longitudinal axis X. The fuselage has a nose 5 and a tail 6 with horizontal and vertical stabilisers 9, 10 near the tail 6. Both the aircraft 1 and the vertical stabilizer 10 are substantially symmetrical about the x-axis. The vertical stabilizer 10 has a symmetrical aerofoil section. Each wing 2, 3 of the aircraft 1 has a cantilevered structure with a length extending in a span-wise direction from a root to a tip, the root being joined to the aircraft fuselage 4. The tips of the wings include wing tip devices 7a, 7b. The aircraft 1 is a typical jet passenger transport aircraft but the invention is applicable to a wide variety of fixed wing aircraft types, including commercial, military, passenger, cargo, jet, propeller, general aviation, etc. with any number of engines attached to the wings or fuselage.

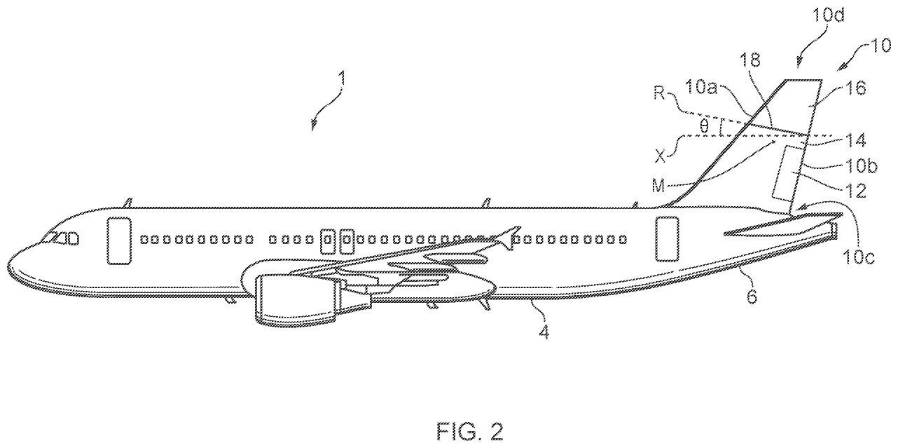

A number of flight control surfaces are located about the aircraft 1. Each wing 2, 3 comprises a plurality of leading edge slats 22, 32, ailerons 23, 33, spoilers 24, 34 and trailing edge flaps 25, 35. Similarly, vertical stabilizer 10 comprises a rudder 12 (shown in FIG. 2), and horizontal stabilizers 9 similarly comprise elevators 9a and 9b. Whilst the aircraft 1 is shown with a particular quantity and configuration of flight control surfaces, it will be understood that the aircraft may comprise a different number and/or arrangement of control surfaces.

The aircraft 1 further comprises flights sensors 20a, 20b located on each wing 2, 3. The flight sensors 20a, 20b are configured to measure a variety of aircraft flight conditions including, but not limited to, aircraft angle of attack, aircraft air speed, an aircraft air speed vector, turbulence, sideslip (beta) angle and lateral acceleration (Ny, Nz). Typically, flights sensors 20a, 20b are alpha and/or beta vane sensors although it shall be appreciated that any suitable flight sensors may be used. Engine sensors 30a, 30b configured to monitor at least one engine condition are also provided at engines 8a and 8b of the aircraft respectively.

Flight sensors 20a, 20b and engine sensors 30a, 30b are each configured to feed back input data to an electronic flight control system (EFCS) 40 located on the aircraft 1. The EFCS 40 is configured to command the various control surfaces of the aircraft, such as ailerons 23, 33, elevators 9a, 9b and rudder 12, based upon various data inputs from the flights sensors 20a, 20b and engine sensors 30a, 30b, in addition to controls provided via the cockpit. EFCS and fly-by-wire (FBW) systems are well known in the art and therefore, for the sake of conciseness, shall not be described any further here.

The vertical stabilizer 10 is shown in FIG. 2 and comprises a leading edge 10a and a trailing edge 10b with a pair of aerodynamic surfaces being defined therebetween, although only one is visible in the side view in FIG. 2. The vertical stabilizer 10 has a span and extends in a spanwise direction vertically from a base, or root, 10c located proximal to the tail end 6 of the fuselage 4, to a tip 10d located distally away from the tail end 6 of the fuselage 4.

The vertical stabilizer 10 has a fixed portion 14 located nearest the base 10c, attached to the tail end 6 of the aircraft fuselage 4, and a moveable portion 16 located nearest the tip 10d, above the fixed portion 14, the fixed portion 14 and the moveable portion 16 being coupled by a hinge 18. The hinge 18 is configured such that the moveable portion 16 is rotatable relative to the fixed portion 14 about a rotational axis R of the hinge 18. In FIG. 2, the hinge 18 is located at a position outboard of a mid-span location M of the vertical stabilizer 10. However, it shall be appreciated that the hinge 18 may be located further inboard.

The hinge line of hinge 18 is inclined at an angle of at least 5 degrees relative to the longitudinal axis X of the fuselage 4, hereinafter referred to as flare angle theta, θ, such that the rotational axis R of the hinge 18 at the leading edge 10a of the vertical stabilizer 10 is located further outboard (relative to the aircraft vertical Z-axis) than the rotational axis R of the hinge 18 at the trailing edge 10b of the vertical stabilizer 10. Typically, the flare angle theta of the hinge 18 has an angle of at least 10 degrees relative to the longitudinal axis X of the fuselage 4, and more typically the flare angle theta of the hinge 18 has an angle of 17.5 degrees relative to the longitudinal axis X of the fuselage 4. However, the flare angle theta does not exceed 40 degrees relative to the longitudinal axis X of the fuselage 4. It shall be appreciated that with a greater flare angle theta, the length of the hinge line shall also subsequently increase in order for the hinge line to extend across the full chord of the vertical stabilizer between the leading edge 10a and the trailing edge 10b. The length of the hinge 18 may also subsequently increase in order to enable the hinge 18 to extend the full length of the chord between the leading and trailing edges 10a, 10b of the vertical stabilizer 10. Alternatively, the hinge 18 may only extend partially along the hinge line such that the hinge 18 may only partially extend across the chord of the vertical stabilizer 10.

Typically, the vertical stabilizer 10 further comprises a seal (not shown) configured so as to suitably cover the hinge 18. The seal acts to minimise interference drag due to the presence of the hinge 18 along the aerodynamic surface of the vertical stabilizer 10. However, it shall be appreciated that in other examples the seal may be omitted.

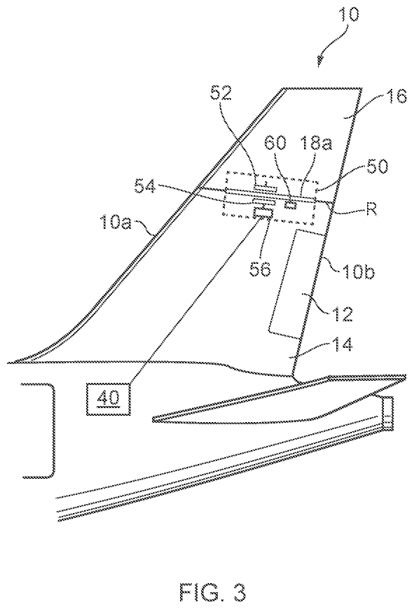

The vertical stabilizer 10 further comprises a locking system which shall now be described in greater detail with reference to FIG. 3.

The locking system 50 comprises a pair of brake pads 52, 54 configured to act on a hinge shaft 18a of the hinge 18, and a brake actuator 56 configured to actuate the brake pads 52, 54 between an unlocked configuration, wherein the brake pads 52, 54 are not in contact with the hinge shaft 18a such that the moveable portion 16 is free to rotate about the hinge 18 relative to the fixed portion 14, and a locked configuration, wherein the brake pads 52, 54 are placed into contact with the hinge shaft 18a such that rotation of the moveable portion 16 about the hinge 18 relative to the fixed portion 14 is not permitted.

The brake actuator 56 is coupled to a locking system controller, EFCS 40. The EFCS 40 is configured to receive input data from flight sensors 20a, 20b, and from the received input data is able to determine the flight phase of the aircraft, for example, by comparing the received input data readings from the flights sensors 20a, 20b to a standard reference data corresponding to various flight phases provided in a look-up table. In one example, the flights sensors 20a, 20b may be configured to measure the airspeed of the aircraft 1. Upon receiving the airspeed input from the flight sensors 20a, 20b, the EFCS 40 can then compare the received airspeed input data with stored airspeed reference data for each flight phase in order to accurately determine the aircraft flight phase. Similarly, in other examples, the flight sensors may instead measure aircraft angle of attack, an air speed vector, sideslip (beta) angle, lateral acceleration (Ny, Nz) or any combination of the above flight conditions in order to determine the flight phase or other condition of the aircraft.

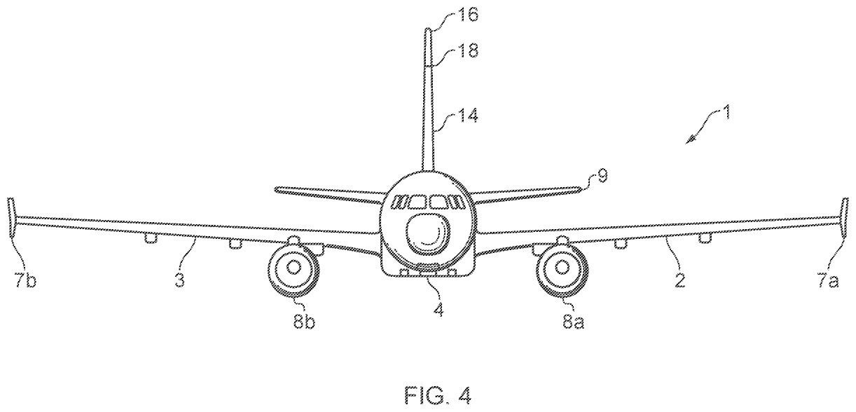

As has been discussed previously, during low speed flight phases, such as take-off and climb flight phases, the full span of the vertical stabilizer 10 is required in order to ensure the aircraft 1 maintains sufficient lateral stability in the event of an engine failure during aircraft take-off or climb flight phases. Therefore, during low speed flight, the brake pads 52, 54 are kept in the locked configuration thereby ensuring the vertical stabilizer 10 is locked in the maximum span position, shown in FIGS. 3 and 4, with the moveable portion and the fixed portion co-planar.

Conversely, during high speed flight phases such as aircraft cruise, the span required to maintain sufficient lateral stability is significantly less than the total span of the vertical stabilizer 10. It is therefore advantageous to allow rotation of the moveable portion 16 of the vertical stabilizer 10 so as to enable loads caused by gusts acting upon the vertical stabilizer 10 to be alleviated, since at high speed flight this effect can be achieved without compromising the lateral stability of the aircraft 1. The size of the fixed portion of the vertical stabilizer may be selected to ensure sufficient lateral stability at high speed. In the event that a high speed flight phase is determined by the EFCS 40, the EFCS 40 commands the brake actuator 56 to release the brake pads 52, 54.

In the event of the EFCS 40 determining that the aircraft has re-entered a low speed flight phase from a high speed flight phase, the EFCS 40 subsequently commands the brake actuator 56 to actuate the brake pads 52, 54 back into the locked configuration thereby ensuring the vertical stabilizer 10 is once again locked in the maximum span position.

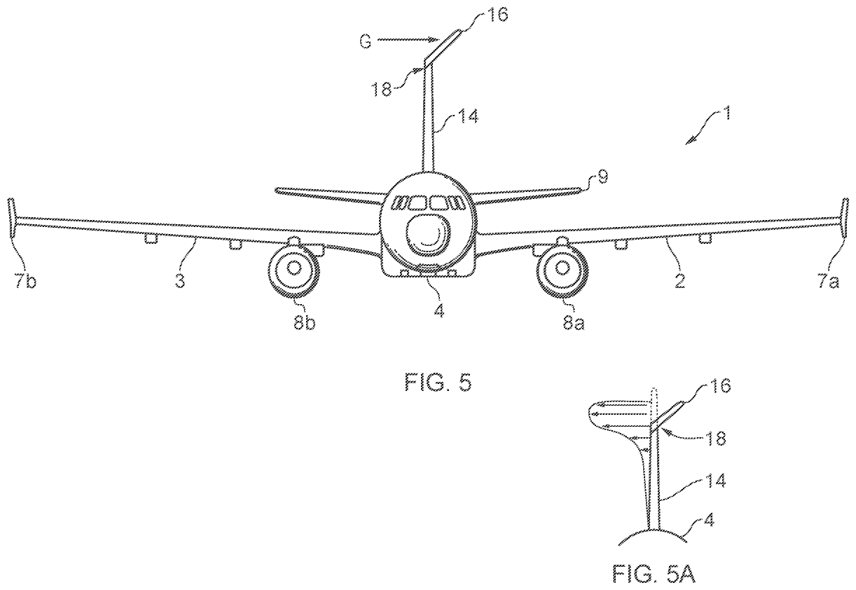

In the illustrated example, the hinge 18 is a semi-passively actuated hinge such that the moveable portion is free to rotate relative to the fixed portion when a gust acts upon the moveable portion 16, when the locking system 50 has been released. In other words, the moveable portion 16 is semi-aeroelastic. This enables the reduction of loads placed on the aircraft 1 due to gusts of wind acting on the moveable portion 16 of the vertical stabilizer 10 since such gusts will actuate the moveable portion 16 to rotate about the hinge 18 and will not be transferred onto the aircraft fuselage 4. The method of gust alleviation will be described later in greater detail with reference to FIGS. 4 and 5.

In an alternative example, the flights sensors 20a, 20b may be configured to also monitor turbulence and provide turbulence input data to the EFCS 40, the EFCS 40 in this example being configured to command the brake actuator 56 to release the brake pads 52, 54 only when the prerequisite flight phase and a sufficient strength of turbulence have been determined based upon the received flight condition input data and turbulence input data from the flight sensors 20a, 20b. In this example, the EFCS 40 may also be programmed to command the brake actuator 56 to place the brake pads 52, 54 in the locked position when either of the prerequisite flight condition or turbulence requirements are not met.

However, in an alternative example, it shall be appreciated that the brake actuator 56 can be commanded to lock and release the brake pads 52, 54 manually, e.g. by the pilot.

Furthermore, whilst the example illustrated in FIG. 3 is described in relation to a braking system, it shall be appreciated that any other suitable locking system may be used.

The method of gust alleviation shall now be described with reference to FIGS. 4 and 5.

FIG. 4 illustrates the movable portion 16 of the vertical stabilizer 10 in a neutral, unfolded position which corresponds to both the locked position, and also to the unlocked position when substantially no gusts or other forms of turbulence are acting on the moveable portion 16 of the vertical stabilizer 10. In the neutral, unfolded position, a first plane defined by the fixed portion 14 and a second plane defined by the moveable portion 16 are substantially co-planar.

Upon encountering a gust when the vertical stabilizer 10 is in an unlocked position, the force G from the gust acting on the moveable portion 16 of the vertical stabilizer 10 causes the moveable portion 16 to rotate about the rotational axis R of the hinge 18 thus placing the moveable portion into a folded position, as shown in FIG. 5. In doing so, the vertical stabilizer 10 prevents any bending moments caused by gusts acting on the moveable portion 16 of the vertical stabilizer 10 from being transferred across the hinge 18 and onto the aircraft 1 thereby providing effective gust load alleviation.

Once the moveable portion 16 is rotated into the folded position, due to the flare angle theta of the hinge 18, the moveable portion 16 exhibits an increased angle of incidence relative to the oncoming airflow. This results in a lifting force being generated at the moveable portion 16. Furthermore, the flare angle theta enables the vertical stabilizer 10 to effectively twist as the moveable portion 16 becomes folded which enables the vertical stabilizer 10 to exhibit a beneficial change in side slip angle as it folds, in other words static stability is provided.

The change in aerodynamic load of due to the flare angle theta of the hinge 18 when the movable portion 16 is in the folded position is further illustrated in FIG. 5a.

The lifting force generated by the flared hinge 18 enables the moveable portion to “self-right” and return from the folded position to the neutral, unfolded position. As the force G applied to the moveable portion 16 wanes, perhaps due to less gusty conditions, the force acting downwardly on the moveable portion 16 due to gusts of wind, in addition to the weight of the moveable portion 16, is no longer balanced by the counteracting lifting forces generated by the lower aerodynamic surface of the moveable portion 16 in the folded position. This subsequently causes the moveable portion 16 to rotate back towards the neutral, unfolded position. The moveable portion 16 will continue to rotate until the downwardly acting forces and the counteracting lifting force become balanced, which in non-gusty conditions will occur when the moveable portion 16 is in the neutral, unfolded position. This provides the further advantage of eliminating the need for an actuator on-board the aircraft to return the moveable portion 16 from the folded position to the unfolded position and hence adds a further weight saving benefit. Once the moveable portion 16 is returned to the neutral, unfolded position, it can be locked back in position via actuation of the brake pads 52, 54 or can remain unlocked with the movable portion 16 being kept in the neutral, unfolded position due to the oncoming airflow acting on the symmetrical vertical stabilizer 10 during level flight until any sufficiently strong gusts act on the moveable portion 16 causing it to rotate.

Whilst the aforedescribed effects can be obtained with substantially any flare angle in excess of 5 degrees, as the flare angle theta, and thus the angle of incidence of the moveable portion 16 in the folded position, is increased, the moveable portion 16 is subsequently able to generate greater amounts of lift when the moveable portion 16 is rotated from the neutral, unfolded position into a folded configuration. Therefore, as the flare angle theta is increased, so too is the relative stiffness of the hinge 18 since, in order to actuate the moveable portion 16, any gusts must have sufficient force G to overcome the additional lifting force generated by the moveable portion 16 due to its greater angle of incidence. In an alternative example, the system sensitivity can also be reduced using a spring and/or damper arrangement.

Furthermore, increasing the flare angle theta enables the beneficial change in the side slip angle to be achieved more efficiently at smaller rotational displacements of the moveable portion 16, due to the twisting of the vertical stabilizer 10 as the moveable portion 16 becomes folded.

The vertical stabilizer also comprises a stop 60 configured restrict the maximum deflection between the first plane of the fixed portion 14 and the second plane of the moveable portion 16 to a maximum of +/−45 degrees. Alternatively, the flare angle theta can be tailored so as to restrict the maximum deflection between the first plane of the fixed portion 14 and the second plane of the moveable portion 16 to a maximum of +/−45 degrees.

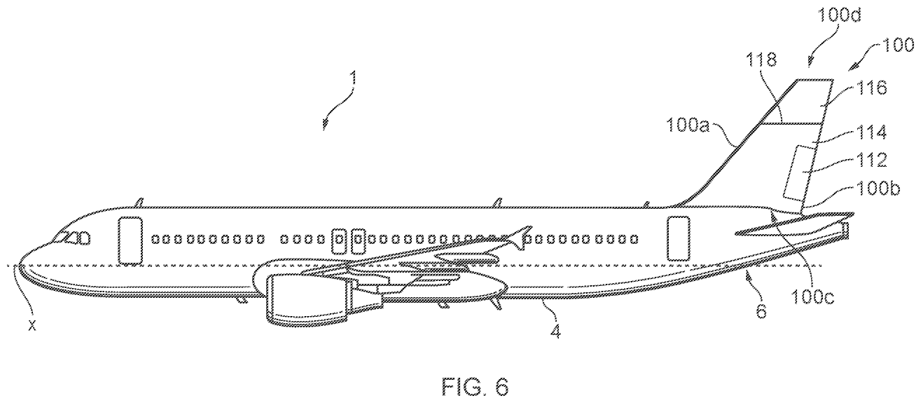

A vertical stabilizer 100 according to an alternative example is shown in FIG. 6. Like reference numerals denote like parts with FIGS. 1 to 5, and only the differences will be described here. As with the vertical stabilizer 10 described in FIG. 2, vertical stabilizer 100 comprises a leading edge 100a and a trailing edge 100b with a pair of aerodynamic surfaces being defined therebetween, and has a span extending in a spanwise direction vertically from a base, or root, 100c located proximal to the tail end 6 of the fuselage 4, to a tip 100d located distally away from the tail end 6 of the fuselage 4.

The vertical stabilizer 100 also includes a fixed portion 114 located nearest the base 100c, attached to the tail end 6 of the aircraft fuselage 4, and a moveable portion 116 located nearest the tip 100d, above the fixed portion 114, the fixed portion 114 and the moveable portion 116 being coupled by a hinge 118. However, unlike the hinge 18 described in FIGS. 2-5, hinge 118 is not flared with the hinge line being substantially parallel to the longitudinal axis X of the fuselage 4.

The hinge 118 of FIG. 6 is also a semi-passively actuated hinge such that the moveable portion 116 is free to rotate relative to the fixed portion 114 when a gust acts upon the moveable portion 116 when the vertical stabilizer 100 is in an unlocked position. The example described in FIG. 6 is therefore able to provide gust alleviation to the vertical stabilizer 100 in much the same way as has been described for the flared hinge of the examples of FIGS. 2-5.

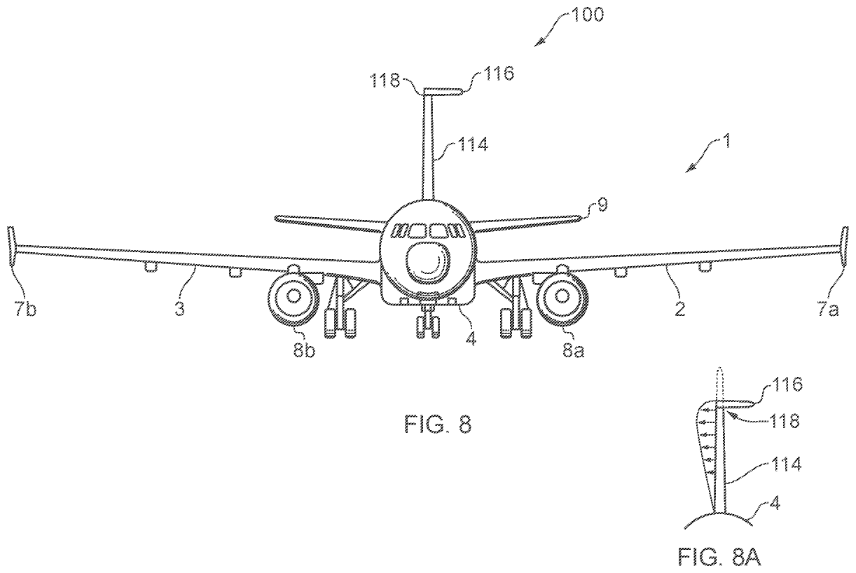

However, due to the unflared nature of the hinge 118 in FIG. 6, the magnitude of lift generated by the moveable portion 116 in the folded position will be significantly reduced since the angle of incidence of the moveable portion 116 will be close to zero during level flight. The aerodynamic loading of the unflared hinge 118 when the movable portion 116 is in the folded position is further illustrated in FIG. 8a. Therefore, this example will typically require some kind of assistance in order to return hinge 118 back to its neutral, unfolded position.

In one example, the EFCS 40 may be configured to receive turbulence or gust input data from the flights sensors 20a, 20b. The EFCS 40 is then programmed to command the aircraft control surfaces to perform gentle lateral manoeuvres to return the moveable portion 116 back to the neutral, unfolded position in response to the gust or turbulence inputs falling below a pre-determined level. Alternatively, the gentle lateral manoeuvres could be performed in response to control commands provided manually by the pilot.

It should be noted that whilst the aforementioned examples have been described in relation to a semi-passive system, it shall be appreciated that the vertical stabilizer may be a fully active system having an actuator configured to move the moveable portion relative to the fixed portion about the hinge.

In one such example, the vertical stabilizer 100 illustrated in FIG. 6 may be used in conjunction with a rotary actuator configured to return the moveable portion back to the neutral, unfolded position.

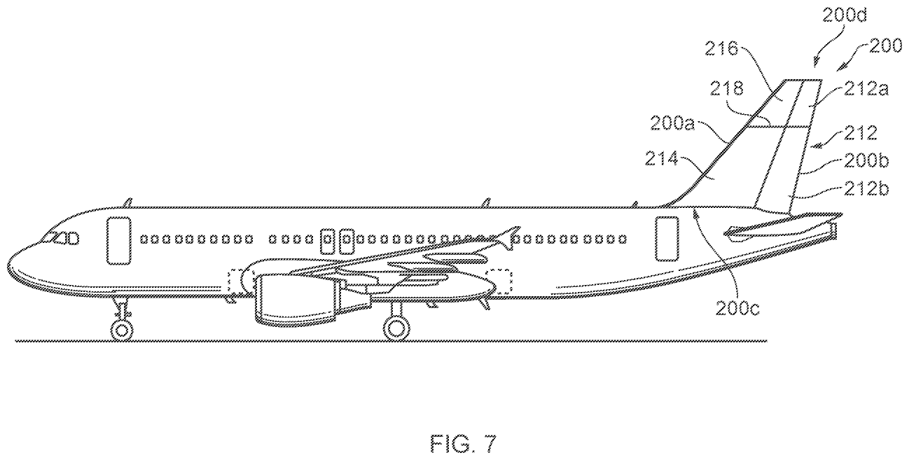

A vertical stabilizer 200 according to a further example is described in FIG. 7 in which the moveable portion 216 is actuated using the rudder 212. The vertical stabilizer 200 is substantially the same as that which is described in FIG. 6 and, as such, like components are denoted by similar reference numerals. However, in the example illustrated in FIG. 7, the rudder 212 is split across the hinge 218 such that a first part of the rudder 212a is provided on the moveable portion 216 and a second part of the rudder 212b is provided on the fixed portion 214.

As the moveable portion 216 is rotated into a folded position, the first part of the rudder 212a can be downwardly actuated to provide the necessary angle of incidence to generate a lifting force acting at the moveable portion 216 thereby enabling the moveable portion 216 to self-right. Meanwhile, the second part of the rudder 212b provides the aircraft with the necessary yaw control required during flight.

An additional benefit of the fully actuated system is the ability for such systems to provide aircraft yaw control. As has been described previously, once the moveable portion 16 is rotated into the folded position, as shown in FIG. 5, due to the flare angle theta of the hinge 18 (or the angle of incidence achieved via the downward actuation of the first part of the rudder 212a), the moveable portion 16 exhibits an increased angle of incidence relative to the oncoming airflow, which results in a lifting force being generated at the moveable portion 16. This generated lifting force will also result in a subsequent increase in drag acting upon the moveable portion 16 which causes the aircraft 1 to yaw. In semi-passive systems, or in scenarios where no yaw is required, the EFCS 40 can be programmed to control the main rudder 12 to account for such yawing. However, in fully actively actuable systems, this effect can also be used to provide a further element of yaw control and could even act as a form of rudder replacement. For example, in response to a yaw command input from the cockpit, the EFCS 40 may be configured to actuate the moveable portion 16 to the folded position.

Whilst the split rudder concept, illustrated in FIG. 7, is described in relation to an unflared hinge 218, it shall be appreciated that the split rudder concept is also applicable for use with a vertical stabilizer featuring a flared hinge, the split rudder in this case providing the benefit of additional yaw tailoring.

Another benefit of the yawing effect provided by the moveable portion is that it can be actuated in response to an engine out, or other emergency engine condition as shall now be described below.

During an engine out event, the magnitude of thrust generated by the portside engine(s) compared with the magnitude of thrust generated by the starboard engine(s) becomes imbalanced. This leads to a significant yawing moment acting on the aircraft 1 which requires compensation in order for the aircraft 1 to continue along a set flight path.

In this example, the EFCS 40 is configured to receive input data from engine sensors 30a, 30b and from the received input data is able to assess engine health by comparing the received input data readings from the engine sensors 30a, 30b to standard reference data corresponding to expected engine conditions during various flight phases provided in a look-up table. Upon receiving the engine input data from the engine sensors 30a, 30b, the EFCS 40 can then compare the received engine input data to stored reference data to accurately determine the engine health status of the aircraft, and hence determine if an engine out event has occurred.

In the event of an engine out condition being met, an over-ride is triggered in which the EFCS 40 commands the brake actuator 56 to release the brake pads 52, 54 and also commands an actuator to actively actuate moveable portion 16 into the folded position so as to provide the necessary yaw compensation required to maintain a flight path during engine out flight. This enables the rudder 12 to function more normally during engine out conditions as the yaw compensation is provided by the moveable portion 16, and therefore enables comparable levels of aircraft manoeuvrability to be achieved during engine out flight with a smaller vertical stabilizer, which subsequently enables both aircraft drag and weight to be reduced. Furthermore, in another example, the EFCS 40 may also be configured to actuate brake pads 52, 54 once the moveable portion 16 has been rotated into the folded position so as to lock the moveable portion 16 in the folded position, ensuring that the desired yaw compensation is maintained throughout engine out flight. In an alternative example, the over-ride may be triggered manually by the pilot.

In yet another example, the locking system 50 and actuator can be further controlled to provide an added storage benefit as shall now be described with reference to FIG. 8.

In FIG. 8, moveable portion 116 is folded into a maximum folded position, in which the first plane, defined by the fixed portion, is substantially perpendicular to the second plane, defined by the movable portion 116. This configuration is beneficial during ground and taxiing flight phases where gates at some airports may have aircraft span or height restrictions.

Upon detection of a ground or taxiing flight phase, the EFCS 40 may be configured to unlock and actuate the moveable portion 116 into the maximum folded position in order to obtain the aforementioned benefits.

As the EFCS 40 detects a take-off flight phase, where a maximum span of the vertical stabilizer 100 is required, the EFCS 40 can be further configured to command the actuator to actuate the moveable portion 116 back to the neutral, unfolded position. The EFCS 40 may also command the brake actuator 56 to lock the moveable portion 116 in the neutral, unfolded position during such flight phases. Similarly, the EFCS 40 may also be programmed to provide this command upon detection of an aircraft landing flight phase. This feature therefore provides the aircraft 1 with the further benefit of improved storage during taxiing and ground phases without compromising lateral stability during low-speed flight phases.

Whilst the above example is described for the unflared hinge 118, described in FIG. 6, it shall be noted that this feature may also be provided using the flared hinge 18 in the method as has been previously described, or may also be provided using the flared hinge 18, locking system 50 and a semi-passive vertical stabilizer system such as that described in FIGS. 2-5. In such a configuration, the moveable portion 16 may be biased into the maximum folded position. Upon detection of a ground or taxiing flight phase, the EFCS 40 may be configured to unlock the locking system 50 such that the moveable portion 16 is able to rotate into the maximum folded position. In this example, the stop 60 may also be omitted to provide the vertical stabilizer 10 with a greater height reduction in the maximum folded position.

As the aircraft begins to take-off, the increased lifting force generated at the moveable portion 16 will cause the moveable portion 16 to self-right, as has been described in reference to FIGS. 4 and 5. Upon detection of a take-off flight phase, the EFCS 40 can also be configured to command the locking system 50 to lock the moveable portion 16 once the moveable portion 16 has been returned to the neutral, unfolded position.

Similarly, upon detection of a ground flight phase following a successful landing, the EFCS 40 can be further configured to unlock the locking system 50 such that the moveable portion 16 is able to once again rotate into the maximum folded position thereby placing the vertical stabilizer 10 into the most beneficial storage configuration for this particular flight phase. The use of a semi-passive hinge also provides the additional benefit of reducing runway times for the aircraft since the aircraft will not be required to wait for actuation of the moveable portion 16 prior to take-off and after landing.

Although the invention has been described above with reference to one or more preferred embodiments, it will be appreciated that various changes or modifications may be made without departing from the scope of the invention as defined in the appended claims.

Where the word ‘or’ appears this is to be construed to mean ‘and/or’ such that items referred to are not necessarily mutually exclusive and may be used in any appropriate combination.

1. A vertical stabilizer for an aircraft, comprising:
a fixed portion configured for attachment to an aircraft fuselage; and
a moveable portion coupled to the fixed portion by a hinge,
wherein a hinge line of the hinge is inclined at an angle of at least 5 degrees, and no greater than 40 degrees, relative to a longitudinal axis of the aircraft fuselage.

2. The vertical stabilizer according to claim 1, wherein the hinge line is inclined at an angle of at least 10 degrees, relative to the longitudinal axis of the aircraft fuselage.

3. The vertical stabilizer according to claim 1, wherein the vertical stabilizer has a span, and the hinge is positioned outboard of a mid-span location of the span of the vertical stabilizer.

4. The vertical stabilizer according to claim 1, further comprising a locking system configured to releasably lock the moveable portion relative to the fixed portion.

5. The vertical stabilizer according to claim 4, wherein the hinge is a semi-passive hinge and configured to allow the moveable portion to freely rotate about the hinge relative to the fixed portion when the locking system is unlocked.

6. The vertical stabilizer according to claim 1, further comprising an actuator configured to move the moveable portion relative to the fixed portion.

7. The vertical stabilizer according to claim 4, wherein the fixed portion defines a first plane, and the moveable portion defines a second plane, and wherein the locking system is configured to lock the moveable portion relative to the fixed portion when the first plane and the second plane are co-planar.

8. The vertical stabilizer according to claim 1, wherein the fixed portion defines a first plane, and the moveable portion defines a second plane, and further comprising a stop to restrict an angle between the first plane and the second plane.

9. The aircraft having a fuselage and the vertical stabilizer of claim 1, wherein the fixed portion is attached to the fuselage.

10. The aircraft according to claim 9 when dependent on claim 4, further comprising a locking system controller coupled to the locking system and configured to lock or release the locking system at one or more flight conditions of the aircraft.

11. The aircraft according to claim 10, wherein locking system controller is coupled to one or more sensors and the locking system controller is configured to automatically lock or release the locking system dependent at least in part on an input received from the sensor(s).

12. The aircraft according to claim 11, wherein the sensor is adapted to sense one or more of: angle of attack, air speed, air speed vector, turbulence, sideslip (beta) angle, lateral acceleration (Ny, Nz) or an engine condition.

13. A vertical stabilizer for an aircraft, comprising:
a fixed portion configured for attachment to an aircraft fuselage;
a moveable portion coupled to the fixed portion by a hinge extending between a leading edge and a trailing edge of the vertical stabilizer; and
a locking system configured to releasably lock the moveable portion relative to the fixed portion,
wherein the hinge is a semi-passive hinge configured to allow the moveable portion to freely rotate about the hinge relative to the fixed portion when the locking system is unlocked.

14. The vertical stabilizer according to claim 13, the vertical stabilizer further comprising a rudder, wherein at least a portion of the rudder is provided on the moveable portion.

15. A method for controlling a vertical stabilizer of an aircraft, the vertical stabilizer having a fixed portion attached to an aircraft fuselage, and a moveable portion coupled to the fixed portion by a hinge, wherein a hinge line of the hinge is inclined at an angle of at least 5 degrees and not more than 40 degrees, relative to a longitudinal axis of the aircraft fuselage, and a locking system configured for locking the moveable portion relative to the fixed portion, the method comprising:
monitoring at least one aircraft condition; and
selectively locking or unlocking the locking system based at least in part on the monitored aircraft condition.

16. The method according to claim 15, wherein the at least one aircraft condition is at least one of: an aircraft flight phase, an aircraft speed, a wind speed, a turbulence level, sideslip (beta) angle, lateral acceleration (Ny, Nz) and an engine condition.

17. The method according to claim 15, wherein the hinge is a semi-passive hinge configured to allow the moveable portion to freely rotate about the hinge relative to the fixed portion when the locking system is unlocked.

18. The vertical stabilizer of claim 2, wherein the angle is at least 15 degrees,

19. The vertical stabilizer of claim 8, wherein the stop is configured to restrict the included angle between the first plane and the second plane to be at most 45 degrees.
